(19) United States
(12) Patent Application Publication
(10) Pub. No.: US 2025/0373622 A1
(43) Pub. Date: Dec. 4, 2025

(54) system and method for avoiding cyber attacks

(71) Applicant: Bank of America Corporation, Charlotte, NC (US)

(72) Inventors: Pushkar Taneja, Hyderabad (IN); Suryanarayana Adivi, Hyderabad (IN); Shailendra Singh, Thane West (IN); Sunilkumar Sriperambudur, Hyderabad (IN)

(21) Appl. No.: 18/677,812

(22) Filed: May 29, 2024

(51) Int. Cl. H04L 9/40; G06F 21/14

(52) U.S. Cl. CPC H04L 63/1408; G06F 21/14; H04L 63/08

(57) ABSTRACT

In response to detecting a request from a first user to perform a data interaction, a set of parameters associated with processing of the requested data interaction is monitored. In response to determining that an anomalous activity has occurred in relation to the processing, a response associated with the processing is obtained and software code included in the response is obfuscated to generated obfuscated code. The software code is replaced with the obfuscated code in the response, and the response including the obfuscated code is transmitted to a user device that initiated the request.

### TECHNICAL FIELD

The present disclosure relates generally to network communication, and more specifically to a system and method for avoiding cyber-attacks in a computing network.

### BACKGROUND

A user may operate a computing node (e.g., a personal computer) to perform a data interaction within a computing network. For example, a client may operate a client device to initiate a request to perform a particular data interaction within the computing network. The request is generally processed by a processing server and a response is transmitted back to the client device. In some cases, an illegitimate user (e.g., a hacker) may place a request to perform an illegitimate data interaction to steal sensitive data, cause damage to systems within the computing network, and or steal digital assets. In some cases, a hacker may intercept the response transmitted to the client device and extract sensitive/private data from the response. Using the information extracted from the response, the hacker may send out a request to perform an unauthorized data interaction on behalf of the legitimate client and/or posing as the legitimate client. This may allow the hacker to inflict various forms of damage upon the legitimate client.

### SUMMARY

The system and method implemented by the system as disclosed in the present disclosure provide technical solutions to the technical problems discussed above by detecting unauthorized data interactions and further avoiding unauthorized data interactions before they occur.

For example, the disclosed system and methods provide the practical application of detecting unauthorized requests for data interactions made by unauthorized users (e.g., a hacker). As described in accordance with embodiments of the present disclosure, in response to detecting a request from a user to perform a data interaction, a security manager monitors a set of parameters associated with processing (e.g., by a processing server) of the requested data interaction and determines, based on the monitoring, whether an anomalous activity has occurred in relation to the processing of the requested data interaction, wherein the anomalous activity comprises at least one activity not known to normally occur when processing the data interaction. The security manager stops the processing of the data interaction and generates and alert in response to detecting one or more anomalous activities in relation to the processing of the requested data interaction.

The disclosed system and methods provide the additional practical application of authenticating a digital identity of a user who placed a request for perform a data interaction in a computing infrastructure. As described in accordance with embodiments of the present disclosure, a in response to detecting a request from a user to perform a data interaction, a security manager generates a first hash key value based at least in part upon a first set of data values included in the request that represent a digital identity of the requesting user. The security manager then compares first hash key value to a verified second hash key value associated with the first user. In response to detecting that the first hash key value does not match with the verified second hash key value, the security manager determines that the digital identity of the first user is not authenticated, generates an alert, and stops processing of the requested data interaction. The verified hash key values associated with users are stored in a blockchain, wherein a verified hash key value associated with a user represents a verified digital identity of the user.

The disclosed system and methods provide the additional practical application of avoiding unauthorized data interactions before they occur. For example, as described in embodiments of the present disclosure, the security manager may be configured to obfuscate response code or a portion thereof included in a response to a user such that a bad actor (e.g., hacker) may not reverse engineer the response code and/or extract useful information from the response code that may otherwise be used to impersonate a legitimate user and perform unauthorized data interactions on behalf of the legitimate user. Obfuscating the response code essentially includes modifying the response code included in the response in a way that avoids a bad actor from extracting useful information form the response code.

By detecting unauthorized requests for data interactions in real-time or near real-time and terminating processing of unauthorized data interactions, the disclosed system and methods improve data security in a computing network. Further, by proactively detecting and terminating unauthorized data interactions the disclosed system and method save computing resources (e.g., processing and/or memory resources) that would otherwise be used to process the unauthorized data interactions. Additionally, by avoiding unauthorized data interactions before they occur also saves computing resources (e.g., processing and/or memory resources) that would otherwise be used to process the unauthorized data interactions. By saving computing resources, the disclosed system and method improve operation of computing nodes used to implement generation and management of sandboxes.

The disclosed system and method provide an additional practical application of improving data security in a computing network by using a blockchain network to save verified digital identities of users. This avoids tampering of the verified digital identities and helps improve the reliability of the digital ID authentication process described in embodiments of the present disclosure, thus improving data security.

Thus, the disclosed system and method generally improves blockchain technology and the technology associated with data security of computing networks.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure;

FIG. 2 illustrates a flowchart of an example method for detecting and/or avoiding unauthorized data interactions in a computing network, in accordance with one or more embodiments of the present disclosure; and

FIG. 3 illustrates a flowchart of an example method for detecting and/or avoiding unauthorized data interactions in a computing network, in accordance with one or more embodiments of the present disclosure.

### DETAILED DESCRIPTION

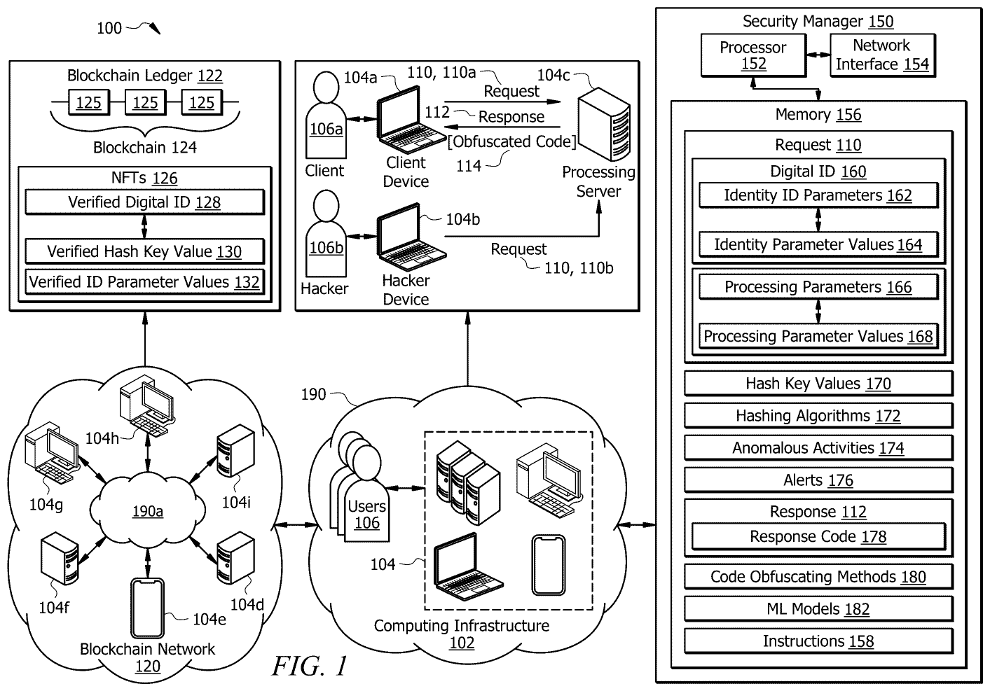

FIG. 1 is a schematic diagram of a system 100, in accordance with certain aspects of the present disclosure. As shown, system 100 includes a computing infrastructure 102 connected to a network 190. Computing infrastructure 102 may include a plurality of hardware and software components. The hardware components may include, but are not limited to, computing nodes 104 such as desktop computers, smartphones, tablet computers, laptop computers, servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes 104 including, but not limited to, operating systems, user interface applications, third party software, database management software, service management software, mainframe software, metaverse software, AI tools and other customized software programs (e.g., security manager 150) implementing particular functionalities. For example, software code relating to one or more software applications may be stored in a memory device and one or more processors (e.g., belonging to one or more computing nodes 104) may execute the software code to implement respective functionalities. An example software application run by one or more computing nodes 104 of the computing infrastructure 102 may include the security manager 150. In one embodiment, at least a portion of the computing infrastructure 102 may be representative of an Information Technology (IT) infrastructure of an organization.

One or more of the computing nodes 104 may be operated by a user 106. In this context, a computing node 104 operated by a user may be referred to as a user device 104. For example, a computing node 104 may provide a user interface using which a user 106 may operate the computing node 104 to perform data interactions within the computing infrastructure 102. The term “computing node 104” may be replaced by “user device 104” in this disclosure when the computing node 104 is operated by a user 106.

One or more computing nodes 104 of the computing infrastructure 102 may be representative of a computing system which hosts software applications that may be installed and run locally or may be used to access software applications running on a server (e.g., processing server 104c). The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server (e.g., processing server 104c) running one or more software applications to implement respective functionality (e.g., processing requests 110) as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

At least a portion of the computing infrastructure 102 may include a blockchain network 120. For example, a portion of the computing nodes 104 may form the blockchain network 120. As shown in FIG. 1, example blockchain network 120 includes computing nodes 104d, 104e, 104f, 104g, 104h, and 104i connected to each other via a portion of the network 190 (shown as 190a). The blockchain network 120 implements distributed computing which generally refers to a method of making multiple computers (e.g., computing nodes 104d-104i) work together to solve a common problem. This makes a computer network (e.g., blockchain network 120) appear as a powerful single computer that provides large-scale resources to deal with complex challenges. For example, distributed computing can encrypt large volumes of data, solve complex physics and chemical equations with many variables, and render high-quality, three-dimensional video animation. Distributed computing often uses specialized software applications that are configured to run on several computing nodes 104 instead of on just one computer, such that different computers perform different tasks and communicate to develop the final solution. High-performing distributed computing is often used in engineering research, financial services, energy sector and the like to run complex processes.

Blockchain network 120 may implement a blockchain 124 across a plurality of the computing nodes 104 (e.g., computing nodes 104a-104f). A blockchain (e.g., blockchain 124) generally is an open, decentralized and distributed digital ledger (e.g., blockchain ledger 122) consisting of records called blocks that are used to record data interactions across many computing nodes (e.g., computing nodes 104). Each computing node 104 of a blockchain network (e.g., blockchain network 120) may maintain a copy of the blockchain ledger (e.g., blockchain ledger 122). Logically, a blockchain is a chain of blocks which contains specific information. As shown in FIG. 1, blockchain 124 includes a chain of blocks 125. Once recorded, the data in any given block 125 cannot be altered retroactively without alteration of all subsequent blocks 125, which requires consensus of the network majority. Each computing node 104 within the blockchain network 120 maintains, approves, and updates new entries. The system is controlled not only by separate individuals, but by everyone within the blockchain network 120. Each member ensures that all records and procedures are in order, which results in data validity and security. Thus, the distributed ledger 122 can record data interactions between two parties (e.g., users 106) efficiently and in a verifiable and permanent way. By design, a blockchain 124 is resistant to modification of the data.

Any new interaction or activity within the blockchain network may trigger the building of a new block of the blockchain. An interaction may include a computing node 104 of the blockchain network transmitting or receiving data from another computing node 104 of the blockchain network or from a computing node that is not part of the blockchain network. Before a new block is added to the blockchain, it needs to be verified by a majority of the computing nodes in the blockchain network.

Each block 125 of the blockchain includes a hash of the block, a hash of the previous block, data that records one or more data interactions or activities associated with the block, and a timestamp of the one or more interactions or activities recorded by the block. The data stored in each block 125 depends on the type of blockchain 124. For example, the data included in a block 125 may include information relating to the data interaction recorded by the block 125 including transmitting/receiving data, details of the data files, a copy of data received or generated as part of the interaction, identities of the sending and receiving nodes involved in the interaction etc. A hash of a block is like a fingerprint that uniquely identifies the block (and the interaction or activity recorded by the block) within the blockchain. Each hash of a block is generated based on a cryptographic hash algorithm.

As described above, a user 106 may operate a computing node 104 (e.g., a personal computer) to perform a data interaction within the computing infrastructure 102. For example, a client 106a (e.g., one of the users 106) may operate a client device 104a (e.g., one of the computing nodes 104) to perform a particular data interaction within the computing infrastructure 102. For example, using a web application running on a web browser at the client device 104a, the client 106a may place a request 110a to a processing server 104c for performing a data interaction. A request 110a may be generated based on user input such as actions or commands the client 106a performs on the web application at the client device 104a. This may include clicking a button, filling out a form, scrolling through content, or any other interaction that requires user input. The user input may cause the web application to generate and transmit a request 110a to the processing server 104c which may be a web server. The request 110a typically contains a plurality of parameter values depending on the user input. Upon receiving the request 110a, the processing server 104c processes the requested data interaction based on the parameters included in the request 110a and generates a response 112 that is transmitted back to the client device 104a. The response 112 may include data requested by the client device 104a and response code 178 (e.g., software code such as HTML code and/or Java script). In one embodiment, data may be embedded in the response code 178 included in the response 112. The web application at the client device 104a renders the response 112 and presents the rendered response on a display associated with the client device 104a. Rendering the response 112 may include running the response code 178 (e.g., HTML code and/or Java script) included in the response 112.

In one example, the web application running at the client device 104a may be a webmail application hosted by the processing server 104c (e.g., email server) and accessed by the client device 104a. In this example, when the client 106a enters a login name and a password associated with an email account associated with the client 106a, a request 110a is transmitted to the processing server 104c (e.g., email server) for emails associated with the email account, wherein the request 110a includes the login name and password entered by the client 106a. Upon receiving the request 110a from the client device 104a, the processing server 104c verifies the login name and password entered by the client 106a and, upon successful verification, retrieves and transmits back to the client device 104a a response 112 including the emails associated with the email account of the client 106a. The response 112 may include response code 178 (e.g., HTML code and/or Java script) that is to be run at the client device 104a to present the emails to the client 106a. Upon receiving the response 112, the client device 104a runs a client-side script including the response code 178 received in the response to present the emails in the web browser on a display associated with the client device 104a.

In some cases, an illegitimate user (e.g., a hacker 106b) may place a request 110b to the processing server 104c to perform an illegitimate data interaction to steal sensitive data, cause damage to systems within the computing infrastructure 102, and or steal digital assets.

In some cases, a hacker 106b may intercept the response 112 transmitted to the client device 104a and extract sensitive/private data from the response 112. For example, the hacker may reverse engineer the response code 178 (e.g., HTML code and/or Java script) included in the response 112 to extract sensitive/private data associated with the client 106a. Following the above example where the response 112 includes email data associated with an email account of the client 106a, the hacker may extract from the response code 178 included in the response 112, sensitive data included in the emails and other metadata included in the response code 178 such as email id of the client 106a, name, a phone number associated with the email account, a network identity of the client device 104a etc. Using the information extracted from the response 112, the hacker 106b may send out own request 110b to perform a data interaction using a hacker device 104b, on behalf of the legitimate client 106a and/or posing as the legitimate client 106a. The processing server 104c may perform the data interaction based on the request 110b from the hacker 106b assuming that the request 110b is placed by the legitimate client 106a. This may allow the hacker 106b to inflict significant financial and reputational damage upon the client 106a. Present systems are generally unable to detect such illegitimate requests and other unauthorized data interactions efficiently and precisely. Further, the present systems do not implement mechanisms to avoid and/or prevent unauthorized data interactions.

Embodiments of the present disclosure describe techniques to detect as well as avoid unauthorized data interactions (e.g., as a result of cyber-attacks) in a computing network (e.g., computing infrastructure 102).

At least a portion of the computing infrastructure 102 (e.g., one or more computing nodes 104) may implement a security manager 150 which may be configured to implement techniques for detecting and avoiding unauthorized data interactions in a computing network (e.g., computing infrastructure 102). The security manager 150 includes a processor 152, a memory 156, and a network interface 154. The security manager 150 may be configured as shown in FIG. 1 or in any other suitable configuration.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

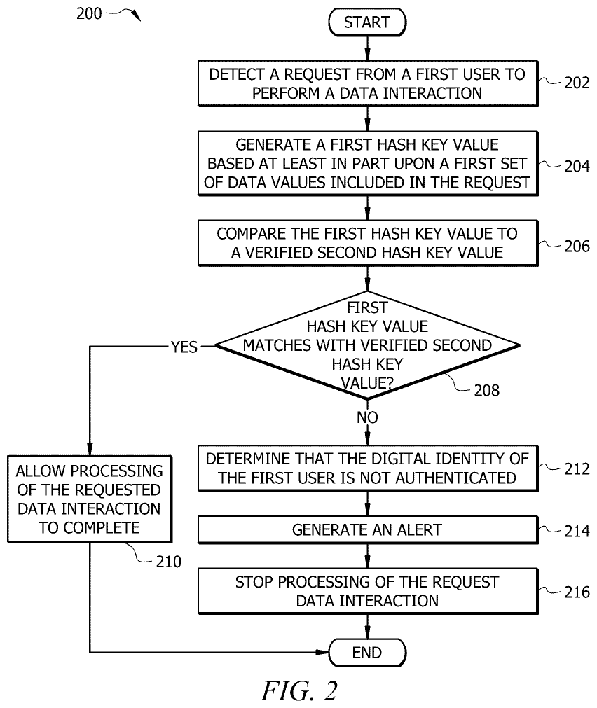

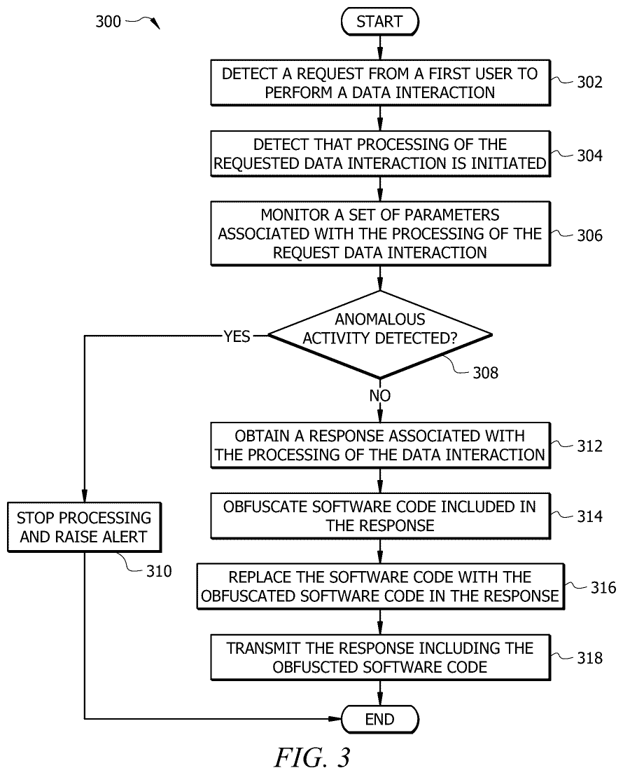

The one or more processors are configured to implement various instructions, such as software instructions. For example, the one or more processors are configured to execute instructions 158 to implement the security manager 150. In this way, processor 152 may be a special-purpose computer designed to implement the functions disclosed herein. In one or more embodiments, the security manager 150 is implemented using logic units, FPGAs, ASICs, DSPs, or any other suitable hardware. The security manager 150 is configured to operate as described with reference to FIGS. 2 and 3. For example, the processor 152 may be configured to perform at least a portion of methods 200 and 300 as described with reference to FIGS. 2 and 3, respectively.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the requests 110, hash key values 170, hashing algorithms 172, anomalous activities 174, alerts 176, responses 112, code obfuscating methods 180, machine learning (ML) algorithms 182, instructions 158, and any other data needed to performed operations of the security manager 150 as described in embodiments of the present disclosure. The instructions 158 may include any suitable set of instructions, logic, rules, or code operable to execute the security manager 150.

The network interface 154 is configured to enable wired and/or wireless communications. The network interface 154 is configured to communicate data between the security manager 150 and other devices, systems, or domains (e.g., computing nodes 104). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that each of the computing nodes 104 may be implemented like the security manager 150 shown in FIG. 1. For example, each of the computing nodes 104 may have a respective processor and a memory that stores data and instructions to perform a respective functionality of the computing node 104.

A request 110 received from a user 106 (e.g., client 106a) may include a plurality of parameters and a parameter value associated with each of the plurality of parameters. As shown in FIG. 1, a request 110 may include one or more identity (ID) parameters 162 and an ID parameter value 164 associated with each ID parameter 162. In this context, one or more ID parameters 162 may be employed to define a digital identity 160 of a user 106. For example, the ID parameters 162 and the respective ID parameter values 164 received in a particular request 110 may define a unique digital identity 160 of a user 106 who placed the particular request 110. Digital IDs 160 associated with different users 106 may be defined by a different set of ID parameter values 168 associated with the same set of ID parameters 162. For example, ID parameters 162 may include, but are not limited to, full name, government ID (e.g., numerical ID assigned to the user), tax ID, username, password, phone number, email address, device ID of a user device (e.g., client device 104a) registered for the user 106, network address of the user device, or combinations thereof. ID parameter values 164 may include actual values of these ID parameters 162 for a particular user 106 such as actual name, government ID number, tax ID number, registered username of the user, registered password of the user, phone number of the user, email address of the user, device ID of the user device (e.g., client device 104a) registered for the user, actual network address of the user device respectively. Thus, digital IDs 160 associated with different users 106 may be defined by different ID parameter values 164 associated with one or more of the above ID parameters 162.

A request 110 received from a user 106 (e.g., client 106a) may further include one or more processing parameters 166 and a processing parameter value 168 associated with each processing parameter 166. A set of one or more processing parameters 166 may be configured to define, at least in part, a particular type of data interaction, and particular processing parameter values 168 associated with the set of processing parameters 166 define, at least in part, a particular data interaction of the type that is requested by a particular request 110. For example, when a particular request 110a initiated by the client 106a requests a data interaction including transfer of a particular amount of data objects from a first data file associated with the client 106a to a second data file associated with a second user 106, the processing parameters 116 that may be configured to define this type of data transfer interaction may include a name of the client 106a, a name of the receiving user, an ID associated with the first data file, an ID associated with the second data file, the amount of data objects to be transferred from the first data file to the second data file, or a combination thereof. In this example, the processing parameter values 168 may include actual values associated with one or more of these processing parameters 166 that define a data transfer interaction. For example, the particular request 110a may include actual data values for each one of processing parameters 166 including actual name of the client 106a, actual name of the receiving user 106, the ID of the first data file, the ID of the second data file, and the particular amount of data objects to be transferred from the first data file to the second data file.

In one or more embodiments, the security manager 150 may be configured to detect unauthorized data interactions requested and/or being processed in a computing network (e.g., computing infrastructure 102). As described in more detail below, security manager 150 may be configured to monitor the processing of a requested data interaction in real-time or near real-time as the processing is performed by one or more computing nodes 104 and identify one or more anomalous activities 174 relating to the processing of the data interaction. In this context, an anomalous activity 174 may include any activity relating to processing a data interaction that is not known to normally occur and/or not expected to occur when processing the data interaction.

Monitoring processing of a particular data interaction may include monitoring a set of parameters associated with processing of the particular data interaction, wherein the set of parameters may include processing parameters 166 included in a request 110 that requested the data interaction, run-time parameters that indicate progression of the processing, and/or other activities that occur when processing the data interaction. Based on monitoring the set of parameters, the security manager 150 may be configured to identify one or more anomalous activities 174 that may occur in relating to processing of the requested data interaction. Anomalous activities 174 which the security manager 150 may be configured to detect in relation to processing of a requested data interaction may include one or more unusual request parameters (e.g., processing parameters 166 and respective processing parameter values 168) received as part of the request 110 that initiated the processing of the data interaction, processing of the data interaction takes longer than an expected to take for a typical processing of the same or similar type of data interaction, unusual memory access patterns during the processing of the data interaction, unusual network access patterns during the processing of the data interaction, receiving multiple requests 110 for the same or similar data interaction from a particular client 106a in a short time period, or a combination thereof. It may be noted that his is not an exhaustive list of anomalous activities 174 that the security manager 150 may be configured to detect. A person having ordinary skill in the art may appreciate that the security manager 150 may be configured to detect any suspicious activity associated with processing of data interactions.

For example, based on monitoring processing parameter values 168 associated with one or more processing parameters 166 included in a request 110a initiated at a client device 104a (e.g., in response to user input from the client 106a), the security manager 150 may detect one or more unusual processing parameter values 168 associated with the request 110a. For example, when the request 110a initiates a data interaction including transfer of a particular amount of data objects from a first data file associated with the client 106a to a second data file associated with a second user 106, security manager 150 may detect an ID associated with the first data file and/or the second data file that is different from respective IDs of the data files previously registered by the client 106a. For example, a hacker 106b may modify the ID of the receiving file included in the request 110a to direct the transfer of the data objects to a data file controlled by the hacker 106b. However, this modified ID of the receiving file may not be previously registered by the client 106a as an authorized receiving data file. Thus, the security manager 150 may detect the inclusion of the modified ID of the receiving data file as an anomalous activity 174.

In another example, unusual memory access patterns the security manager 150 may be configured to identify may include unusual accesses and/or modifications to a memory used for processing the requested data interaction. For example, a temporary cache memory may temporarily store data while processing the data interaction. A hacker may hack into the cache memory and change data from the cache memory, for example, to redirect the data transfer to an unauthorized recipient data file. Such unusual changes to the memory may be determined as an anomalous activity 174.

In another example, unusual network access patterns the security manager 150 may be configured to identify may include re-direction of the processing to an unusual processing server. For example, the hacker 106b may redirect processing of the requested data interaction from an original processing server 104c that is configured to process the request 110 to another unauthorized processing server that may allow the hacker to control the processing. Such unusual network access activity may be determined as an anomalous activity 174.

In one or more embodiments, the security manager may employ an ML model 182 to detect anomalous activities 174 associated with processing of requested data interactions. The ML model 182 may be trained based on data values of a plurality of parameters that correspond to known anomalous activities. Once trained, the ML model 182 may be input with the request 110 received from a user (e.g., a client 106a) and parameter values associated with a plurality of parameters described above in real-time as the processing of a data interaction occurs. Based on the request 110 and/or the parameter values, the ML model 182 may identify anomalous activities.

In certain embodiment, in response to detecting one or more anomalous activities in relation to processing of the requesting data interaction, security manager 150 may be configured to stop (e.g., at least temporarily) processing of the data interaction. Additionally, or alternatively, security manager 150 may be configured to generate an alert 176 indicating that one or more anomalous activities 174 are detected, wherein alert 176 may include information relating to the detected one or more anomalous activities 174.

In one or more embodiments, the security manager 150 may be configured to verify a digital identity 160 associated with a user 106 (e.g., client 106a) who placed a request 110 (e.g., request 110a) for conducting a data interaction. In certain embodiments, blockchain technology and hashing technology may be used to verify/authenticate the digital identity 160 of a requesting user (e.g., client 106a). Authenticating the digital identity 160 of a user 106 who placed a request 110 generally includes checking whether the user 106 is a legitimate user authorized to the data interaction requested in the request 110. In this context, for each user 106, the blockchain 124 stores (e.g., as part of the blockchain ledger 122) a verified digital ID 128 and a verified hash key value 130 associated with the verified digital ID 128. One or more ID parameters 162 may be configured to define verified digital IDs 128 associated with users 106. The verified digital ID 128 of each user 106 may be defined by a verified set of unique ID parameter values 164 for the ID parameters 162 configured to define verified digital IDs128. For example, verified digital IDs 128 for different users 106 are associated with different verified ID parameter values 132 for the same ID parameters 162 configured to define verified digital IDs 128. In alternative embodiments, verified digital IDs 128 associated with different users 106 may be defined by different set of one or more ID parameters 162 and their respective ID parameter values 164.

A verified hash key value 130 associated with a verified digital ID 128 is generated by running a pre-configured hashing algorithm 172 based on the verified ID parameter values 132 associated with the verified digital ID 128. As the verified digital IDs 128 and associated verified hash key values 130 are stored in the blockchain 124, they may not be easily tampered with due to the inherent immutable nature of blockchains.

In one or more embodiments, the verified digital ID 128, and the associated verified hash key value 130 relating to a user 106 may be associated with a Non-Fungible Token (NFT) 126 stored in the blockchain 124. An NFT 126 is generally generated for a particular digital asset and includes information relating to the digital asset, and further includes a unique digital signature that cannot be changed as NFTs 126 are stored in a distributed network such as a blockchain (e.g., blockchain 124). Since NFTs 126 cannot be modified easily, this greatly reduces the possibility of bad actors tampering with the NFT. In the context of the present disclosure, given a particular NFT 126, the digital asset associated with the NFT 126 is the verified digital ID 128 of a user 106 and the digital signature associated with the NFT 126 is the corresponding verified hash key value 130. Essentially, each NFT 126 serves as a unique verified digital signature of a particular user 106 represented by a verified digital ID 128 and a corresponding verified hash key value 130 associated with the NFT 126.

The security manager 150 may be configured to authenticate a digital ID 160 of a user 106 (e.g., client 106a) who placed a request 110 (e.g., request 110a) based on the verified digital ID 128 associated with the requesting user 106 stored in the blockchain 124. In certain embodiments, in response to detecting that a request (e.g., request 110a or request 110b) from a user 106 (e.g., client 106a or hacker 106b) has been initiated to perform a data interaction, the security manager 150 extracts from the request 110, one or more ID parameters 162 and respective ID parameter values 164 that are part of the digital identity 160 of the requesting client 106a included in the request 110. Once the ID parameter values 164 included in the request 110 has been obtained, the security manager 150 generates a hash key value 170 based on one or more of the ID parameter values 164 included in the request 110 by running a hashing algorithm based on the one or more ID parameter values 164. The security manager 150 also obtains from the blockchain network 120, a verified hash key value 130 associated with the verified digital ID 128 associated with the presumed requesting user 106. The security manager 150 compares the verified hash key value 130 to the hash key value 170 generated based on the ID parameter values 164 included in the request 110. Based on this comparison, security manager 150 may be configured to determine whether the user 106 who initiated the request 110 is a legitimate user who is authorized to perform the data interaction requested by the request 110. For example, when the hash key value 170 matches with the verified hash key value 130, the security manager 150 determines that the requesting user 106 is a legitimate user (e.g., the client 106a) who is authorized to perform the requested data interaction. On the other hand, when the hash key value 170 does not match with the verified hash key value 130, the security manager 150 determines that the requesting user 106 is not a legitimate user and is not authorized to perform the requested data interaction. For example, the security manager 150 may determined that the requesting user is an unauthorized user (e.g., a hacker 106b) who placed the request 110a posing as the legitimate user (e.g., the client 106a)

In one or more embodiments, the security manager 150 may be configured to generate the hash key value 170 based on ID parameter values 164 associated with the same set of ID parameters 162 based on which the verified hash key value 130 was generated. For example, if the verified hash key value 130 was generated based on a phone number, email address, and device ID of a user device registered for the user 106, then the security manager 150 generates the hash key value 170 also based on the phone number, email address, and device ID of the requesting user device (e.g., client device 104a or hacker device 104b). Further, to generate the hash key value 170 based on the ID parameter values 164 included in the request 110, security manager 150 may be configured to use the same hashing algorithm 172 that was also used to generate the verified hash key value 130 associated with the user 106. This way, when the verified ID parameter values 132 and the ID parameter values 164 included in the request 110 match, the verified hash key value 130 generated based on the verified ID parameter values 132 and the hash key value 170 generated based on the ID parameter values 164 (included in the request 110) also match.

In one or more embodiments, security manager 150 may be configured to implement the process for authenticating the digital ID 160 of the requesting user 106 after performing the anomaly detection process also described above. For example, security manager 150 may be configured to authenticate the digital ID 160 of the requesting user 106 (e.g., by comparing generated and verified hash key values) in response to detecting that one or more anomalous activities 174 have been detected in relating to processing of the request 110. In certain embodiment, in response to determining that the digital identity 160 of the requesting user 106 has not been authenticated, security manager 150 may be configured to stop (e.g., at least temporarily) processing of the data interaction requested using the request 110. Additionally, or alternatively, security manager 150 may be configured to generate an alert 176 indicating that the digital identity 160 of the requesting user 106 is not authenticated. Additionally, or alternatively, the alert 176 may additionally include an indication that one or more anomalous activities 174 are detected, wherein alert 176 may further include information relating to the detected one or more anomalous activities 174.

### Avoiding Unauthorized Data Interactions by Obfuscating Software Code Included in a Response to a Request

As described above, in some cases, a hacker 106b may intercept a response 112 transmitted to a client device 104a and extract sensitive/private data from the response 112. For example, the hacker may reverse engineer the response code 178 (e.g., software code such as HTML code and/or Java script) included in the response 112 to extract sensitive/private data associated with the client 106a. Following an example described above where the response 112 includes email data associated with an email account of the client 106a, the hacker may extract from the response code included in the response 112, sensitive data included in the emails and other metadata included in the response code 178 such as email id of the client 106a, name, a phone number associated with the email account, a network identity of the client device 104a etc. Using the information extracted from the response 112, the hacker 106b may send out own request 110b to perform a data interaction using a hacker device 104b, on behalf of the legitimate client 106a and/or posing as the legitimate client 106a. The processing server 104c may perform the data interaction based on the request 110b from the hacker 106b assuming that the request 110b is placed by the legitimate client 106a. This may allow the hacker 106b to inflict significant financial and reputational damage upon the client 106a. Present systems do not implement mechanisms to avoid and/or prevent unauthorized data interactions.

Security manager 150 may be configured to implement methods to avoid and/or prevent unauthorized data interactions from malicious actors. In this context, the security manager 150 may be configured to obfuscate the response code 178 or a portion thereof included in a response 112 such that a bad actor (e.g., hacker 106b) may not reverse engineer the response code 178 and/or extract useful information from the response code 178 that may otherwise be used to impersonate a legitimate user 106 (e.g., client 106a) and perform data interactions on behalf of the legitimate user 106. Obfuscating the response code 178 essentially includes modifying the response code 178 included in the response 112 in a way that avoids a bad actor from extracting useful information form the response code 178.

The security manager 150 may be configured to obfuscate the response code 178 or a portion thereof using one or more code obfuscating methods 180 (described in more detail below) to generate obfuscated code 114. The security manager 150 may be configured to replace the response code 178 with the obfuscated code 114 in the response 112 and transmit back to the user 106 the response 112 including the obfuscated code 114. For example, in response to receiving a request 110a from a client device 104a, the processing server 104c may process a data interaction requested via the request 110a and generate a response 112 including response code 178. The security manager 150 may obfuscate the response code 178 using one or more code obfuscating methods and replace the response code 178 with the obfuscated code 114. The response 112 including the obfuscated code 114 is then transmitted back to the client device 104a. In one embodiment, the obfuscated code 114 is configured to be decoded and executed by the client device 104a to present at least a portion of the response 112 on a display associated with the client device 104a. It may be noted that obfuscated code 114 may be decoded only by the client device 104a that sent the request 110a, but no other computing node 104 in the computing infrastructure 102. This avoids a bad actor from extracting useful information form the response code 178.

In certain embodiments, the security manager 150 allows a designated processing server 104c to continue and complete processing of a data interaction requested via a request 110 only when no anomalous activities 174 are detected in relation to the requested data interaction. In other words, processing of the requested data interaction is completed and a response 112 is generated only when no anomalous activities 174 are detected in relation to the processing of the requested data interaction. Additionally, or alternatively, processing of the requested data interaction is completed and a response 112 is generated only when the digital ID 160 of the requesting user 106 is successfully authenticated. Thus, in certain embodiments, the security manager 150 obtains the response 112 associated with a request 110 in response to determining that no anomalous activities 174 are detected in relation to the processing of the requested data interaction. The security manager 150 then proceeds to obfuscate the response code 178 included in the obtained response 112 before transmitting the response 112 including the obfuscated code 114 back to the requesting user 106. In additional or alternative embodiments, the security manager 150 obtains the response 112 associated with a request 110 in response to successfully authenticating the digital ID 160 of the user who transmitted the corresponding request 110. The security manager 150 then proceeds to obfuscate the response code 178 included in the obtained response 112 before transmitting the response 112 including the obfuscated code 114 back to the requesting user 106.

The code obfuscating methods 180 that the security manager 150 may use to obfuscate the response code 178 or a portion thereof may include name obfuscation, control flow obfuscation, string obfuscation, code splitting, code merging, dead code insertion, control flow flattening, code substitution, function inlining, context-aware string obfuscation, polymorphic code generation, or a combination thereof.

In certain embodiments, name obfuscation is a code obfuscating method 180 that involves renaming variables, functions, and classes within the response code 178 to use meaningless or misleading names. By doing so, it becomes harder for attackers to determine the purpose and flow of the response code 178.

In certain embodiments, control flow obfuscation is a code obfuscating method 180 that modifies the order and structure of control flow statements (such as loops, conditionals, and function calls) within the response code 178. This method introduces additional unnecessary instructions or branches to make the response code 178 appear more convoluted, confusing attackers attempting to understand the response code's execution flow.

In certain embodiments, string obfuscation is a code obfuscating method 180 that encrypts and/or encodes strings used within the response code 178, which makes it harder for attackers to extract sensitive information or understand the purpose of the response code 178. The strings must be decrypted and decoded during runtime, hindering reverse engineering attempts.

In certain embodiments, Code Splitting and Merging is a code obfuscating method 180 that involves splitting the response code 178 into multiple modules or files and then merging them during runtime (e.g., at the client device 104a). It makes the reverse engineering process more difficult by scattering the logic across multiple files and obfuscating the overall structure of the response code 178.

In certain embodiments, Dead Code Insertion is a code obfuscating method 180 that inserts additional unused code segments into the client-side response code 178. This serves the purpose of confusing attackers and increasing the complexity of the response code 178. By including unnecessary functions or code branches, attackers are faced with more challenges when trying to understand the code's actual functionality.

In certain embodiments, Control Flow Flattening is a code obfuscating method 180 that includes transforming the response code's control flow into a maze-like structure which makes the response code 178 extremely convoluted, making it harder for attackers to understand the code's execution path.

In certain embodiments, Code Substitution is a code obfuscating method 180 that includes replacing sections of the response code 178 with equivalent but harder-to-understand alternatives, such as replacing a simple mathematical operation with a complex mathematical expression.

In certain embodiments, Function Inlining is a code obfuscating method 180 that includes inline code snippets throughout the response code 178 (e.g., instead of using separate functions), making it harder for attackers to trace flow of the response code 178.

In certain embodiments, Context-aware String Obfuscation is a code obfuscating method 180 that selectively encrypts or encodes sensitive strings included in the response code 178 based on the context in which they are used. By encrypting only relevant strings, the response code 178 remains smaller and less prone to detection by attackers.

In certain embodiments, Polymorphic Code Generation is a code obfuscating method 180 that includes using AI/ML algorithms to generate code variants with equivalent functionality but different structures and representations. This technique confuses attackers attempting to understand and modify the response code 178 at a deeper level.

FIG. 2 illustrates a flowchart of an example method 200 for detecting and/or avoiding unauthorized data interactions in a computing network, in accordance with one or more embodiments of the present disclosure. Method 200 may be performed by the security manager 150 shown in FIG. 1. At operation 202, the security manager 150 detects a request 110 (e.g., 110a or 110b) from a first user 106 (e.g., client 106a or hacker 106b) to perform a data interaction, wherein the request 110 includes a digital identity 160 associated with the first user 106, wherein the digital identity 160 associated with the first user 106 includes a first set of data values (e.g., ID parameter values 164) associated with a plurality of parameters (e.g., ID parameters 162) configured to define the digital identity 160 of the first user 106.

As described above, a user 106 may operate a computing node 104 (e.g., a personal computer) to perform a data interaction within the computing infrastructure 102. For example, a client 106a (e.g., one of the users 106) may operate a client device 104a (e.g., one of the computing nodes 104) to perform a particular data interaction within the computing infrastructure 102. For example, using a web application running on a web browser at the client device 104a, the client 106a may place a request 110a to a processing server 104c for performing a data interaction. A request 110 (e.g., request 110a) received from a user 106 (e.g., client 106a) may include a plurality of parameters and a parameter value associated with each of the plurality of parameters. As shown in FIG. 1, a request 110 may include one or more identity (ID) parameters 162 and an ID parameter value 164 associated with each ID parameter 162. In this context, one or more ID parameters 162 may be employed to define a digital identity 160 of a user 106. For example, the ID parameters 162 and the respective ID parameter values 164 received in a particular request 110 may define a unique digital identity 160 of a user 106 who placed the particular request 110. Digital IDs 160 associated with different users 106 may be defined by a different set of ID parameter values 168 associated with the same set of ID parameters 162.

At operation 204, the security manager 150 generates a first hash key value (e.g., hash key value 170) based at least in part upon the first set of data values (e.g., ID parameter values 164).

As described above, the security manager 150 may be configured to verify a digital identity 160 associated with a user 106 (e.g., client 106a) who placed a request 110 (e.g., request 110a) for conducting a data interaction. In certain embodiments, in response to detecting that a request (e.g., request 110a or request 110b) from a user 106 (e.g., client 106a or hacker 106b) has been initiated to perform a data interaction, the security manager 150 extracts from the request 110, one or more ID parameters 162 and respective ID parameter values 164 that are part of the digital identity 160 of the requesting client 106a included in the request 110. Once the ID parameter values 164 included in the request 110 has been obtained, the security manager 150 generates a hash key value 170 based on one or more of the ID parameter values 164 included in the request 110 by running a hashing algorithm based on the one or more ID parameter values 164.

At operation 206, the security manager 150 compares the first hash key value (e.g., ID parameter values 164) to a verified second hash key value (e.g., verified hash key value 130) associated with the first user 106, wherein the verified second hash key value (e.g., verified hash key value 130) is generated based at least in part upon a verified second set of data values (e.g., verified ID parameter values 132) associated with the plurality of parameters (e.g., ID parameters 162).

As described above, security manager 150 may be configured to authenticate a digital ID 160 of a user 106 (e.g., client 106a) who placed a request 110 (e.g., request 110a) based on a verified digital ID 128 associated with the requesting user 106 stored in the blockchain 124. In certain embodiments, blockchain technology and hashing technology may be used to verify/authenticate the digital identity 160 of a requesting user (e.gl, client 106a). Authenticating the digital identity 160 of a user 106 who placed a request 110 generally includes checking whether the user 106 is a legitimate user authorized to the data interaction requested in the request 110. In this context, for each user 106, the blockchain 124 stores (e.g., as part of the blockchain ledger 122) a verified digital ID 128 and a verified hash key value 130 associated with the verified digital ID 128. One or more ID parameters 162 may be configured to define verified digital IDs 128 associated with users 106. The verified digital ID 128 of each user 106 may be defined by a verified set of unique ID parameter values 164 for the ID parameters 162 configured to define verified digital IDs128. For example, verified digital IDs 128 for different users 106 are associated with different verified ID parameter values 132 for the same ID parameters 162 configured to define verified digital IDs 128. In alternative embodiments, verified digital IDs 128 associated with different users 106 may be defined by different set of one or more ID parameters 162 and their respective ID parameter values 164.

A verified hash key value 130 associated with a verified digital ID 128 is generated by running a pre-configured hashing algorithm 172 based on the verified ID parameter values 132 associated with the verified digital ID 128. As the verified digital IDs 128 and associated verified hash key values 130 are stored in the blockchain 124, they may not be easily tampered with due to the inherent immutable nature of blockchains.

In addition to generating the hash key value 170 based on one or more of the ID parameter values 164 included in the request 110, the security manager 150 also obtains from the blockchain network 120, a verified hash key value 130 associated with the verified digital ID 128 associated with the presumed requesting user 106. The security manager 150 compares the verified hash key value 130 to the hash key value 170 generated based on the ID parameter values 164 included in the request 110. Based on this comparison, security manager 150 may be configured to determine whether the user 106 who initiated the request 110 is a legitimate user who is authorized to perform the data interaction requested by the request 110.

At operation 208, the security manager 150 checks whether the first hash key value (e.g., ID parameter values 164) matches with the verified second hash key value (e.g., verified hash key value 130) associated with the first user 106.

When the first hash key value is determined to match the verified second hash key value, method 200 proceeds to operation 210 where the security manager allows processing of the requested data interaction to complete. For example, when the hash key value 170 matches with the verified hash key value 130, the security manager 150 determines that the requesting user 106 is a legitimate user (e.g., the client 106a) who is authorized to perform the requested data interaction. As described above, a response 112 may be generated (e.g., by a processing server 104c) as a result of processing the requested data interaction, wherein the response 112 may include response code 178. The response code 178 may be obfuscated as described above using one or more code obfuscating methods 180 to generate obfuscated code 114. The response 112 and the obfuscated code 114 are transmitted back to the requesting user 106 (e.g., user who initiated the request 110) where the at least a portion of the response 112 is rendered and presented on a display associated with a user device (e.g., client device 104a) associated with the user 106.

When (at operation 208) the first hash key value (e.g., ID parameter values 164) does not match with the verified second hash key value (e.g., verified hash key value 130), method 200 proceeds to operation 212.

At operation 212, in response to determining, based on comparing the first hash key value and the verified second hash key value, that the first hash key value does not match with the verified second hash key value, the security manager 150 determines that the digital identity 160 of the first user 106 is not authenticated.

At operation 214, the security manager 150 generates an alert 176 indicating that the digital identity 160 of the first user 106 is not authenticated.

At operation 216, the security manager 150 stops processing of the requested data interaction.

As described above, when the hash key value 170 does not match with the verified hash key value 130, the security manager 150 determines that the requesting user 106 is not a legitimate user and is not authorized to perform the requested data interaction. For example, the security manager 150 may determine that the requesting user is an unauthorized user (e.g., a hacker 106b) who placed the request 110a posing as the legitimate user (e.g., the client 106a). In certain embodiment, in response to determining that the digital identity 160 of the requesting user 106 has not been authenticated, security manager 150 may be configured to stop (e.g., at least temporarily) processing of the data interaction requested using the request 110. Additionally, or alternatively, security manager 150 may be configured to generate an alert 176 indicating that the digital identity 160 of the requesting user 106 is not authenticated.

FIG. 3 illustrates a flowchart of an example method 300 for detecting and/or avoiding unauthorized data interactions in a computing network, in accordance with one or more embodiments of the present disclosure. Method 300 may be performed by the security manager 150 shown in FIG. 1.

At operation 302, the security manager 150 detects a request 110 (e.g., 110a or 110b) from a first user 106 (e.g., client 106a or hacker 106b) to perform a data interaction.

As described above, a user 106 may operate a computing node 104 (e.g., a personal computer) to perform a data interaction within the computing infrastructure 102. For example, a client 106a (e.g., one of the users 106) may operate a client device 104a (e.g., one of the computing nodes 104) to perform a particular data interaction within the computing infrastructure 102. For example, using a web application running on a web browser at the client device 104a, the client 106a may place a request 110a to a processing server 104c for performing a data interaction.

At operation 304, the security manager 150 detects that processing of the requested data interaction is initiated.

At operation 306, the security manager 150 monitors the set of parameters (e.g., processing parameters 166) associated with the processing of the requested data interaction.

As described above, security manager 150 may be configured to monitor the processing of a requested data interaction in real-time or near real-time as the processing is performed by one or more computing nodes 104 and identify one or more anomalous activities 174 relating to the processing of the data interaction. In this context, an anomalous activity 174 may include any activity relating to processing a data interaction that is not known to normally occur and/or not expected to occur when processing the data interaction.

Monitoring processing of a particular data interaction may include monitoring a set of parameters associated with processing of the particular data interaction, wherein the set of parameters may include processing parameters 166 included in a request 110 that requested the data interaction, run-time parameters that indicate progression of the processing, and/or other activities that occur when processing the data interaction.

At operation 308, the security manager 150 determines, based on the monitoring, whether anomalous activity 174 has occurred relating to processing of the data interaction, wherein the anomalous activity 174 includes at least one activity not known to normally occur when processing the data interaction.

As described above, based on monitoring the set of parameters, the security manager 150 may be configured to identify one or more anomalous activities 174 that may occur in relating to processing of the requested data interaction. Anomalous activities 174 which the security manager 150 may be configured to detect in relation to processing of a requested data interaction may include one or more unusual request parameters (e.g., processing parameters 166 and respective processing parameter values 168) received as part of the request 110 that initiated the processing of the data interaction, processing of the data interaction takes longer than an expected to take for a typical processing of the same or similar type of data interaction, unusual memory access patterns during the processing of the data interaction, unusual network access patterns during the processing of the data interaction, receiving multiple requests 110 for the same or similar data interaction from a particular client 106a in a short time period, or a combination thereof.

When one or more anomalous activities 174 are detected in relation to processing the request data interaction, method 300 proceeds to operation 310, where the security manager 150 stops processing of the requested data interaction and raises an alert indicating that one or more anomalous activities 174 are detected in relation to processing the request data interaction. In one embodiment, as described above, in response to detecting one or more anomalous activities 174 in relation to processing the request data interaction, the security manager 150 proceeds to verify the digital identity 160 of the user 106 who initiated the request 110. As described above, security manager 150 may authenticate the digital ID 160 of the user 106 by comparing a hash key value 170 generated based on ID parameter values 164 included in the request 110 with a verified hash key value 130 associated with the user 106.

When no anomalous activity 174 is detected in relation to processing of the requested data interaction, method 300 proceeds to operation 312.

At operation 312, in response to determining that no anomalous activity 174 has occurred relating to processing the data interaction, the security manager 150 obtains a response 112 associated with the processing of the data interaction, wherein the response 112 includes software code (e.g., response code 178) to be executed by a user device 104 (e.g., client device 104a) to present at least a portion of the response 112 on a display associated with the user device 104.

At operation 314, the security manager 150 obfuscates at least a portion of the software code (e.g., response code 178) included in the response 112.

At operation 316, the security manager 150 replaces the portion of the software code (e.g., response code 178) with the obfuscated software code (e.g., obfuscated code 114) in the response 112.

At operation 318, the security manager 150 transmits to the user device 104, the response 112 including the obfuscated software code (e.g., obfuscated code 114).

As described above, the security manager 150 may be configured to obfuscate the response code 178 or a portion thereof included in a response 112 such that a bad actor (e.g., hacker 106b) may not reverse engineer the response code 178 and/or extract useful information from the response code 178 that may otherwise be used to impersonate a legitimate user 106 (e.g., client 106a) and perform data interactions on behalf of the legitimate user 106. Obfuscating the response code 178 essentially includes modifying the response code 178 included in the response 112 in a way that avoids a bad actor from extracting useful information form the response code 178.

The security manager 150 may be configured to obfuscate the response code 178 or a portion thereof using one or more code obfuscating methods 180 (described in more detail below) to generate obfuscated code 114. The security manager 150 may be configured to replace the response code 178 with the obfuscated code 114 in the response 112 and transmit back to the user 106 the response 112 including the obfuscated code 114. For example, in response to receiving a request 110a from a client device 104a, the processing server 104c may process a data interaction requested via the request 110a and generate a response 112 including response code 178. The security manager 150 may obfuscate the response code 178 using one or more code obfuscating methods and replace the response code 178 with the obfuscated code 114. The response 112 including the obfuscated code 114 is then transmitted back to the client device 104a. In one embodiment, the obfuscated code 114 is configured to be decoded and executed by the client device 104a to present at least a portion of the response 112 on a display associated with the client device 104a. It may be noted that obfuscated code 114 may be decoded only the client device 104a that sent the request 110a, but no other computing node 104 in the computing infrastructure 102. This avoids a bad actor from extracting useful information form the response code 178.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a memory that stores a set of parameters associated with processing of data interactions; and
a processor communicatively coupled to the memory and configured to:
detect a request from a first user to perform a data interaction;
detect that processing of the requested data interaction is initiated;
monitor the set of parameters associated with the processing of the requested data interaction;
determine, based on the monitoring, whether anomalous activity has occurred relating to processing of the data interaction, wherein the anomalous activity comprises at least one activity not known to normally occur when processing the data interaction;
in response to determining that no anomalous activity has occurred relating to processing the data interaction, obtain a response associated with the processing of the data interaction, wherein the response comprises software code to be executed by a user device to present at least a portion of the response on a display associated with the user device;
obfuscate at least a portion of the software code comprised in the response;
replace the portion of the software code with the obfuscated software code in the response; and
transmit to the user device, the response including the obfuscated software code.

2. The system of claim 1, wherein the obfuscated code is configured to be decoded and executed by the user device to present at least the portion of the response on the display associated with the user device.

3. The system of claim 1, wherein the set of parameters associated with the processing of the requested data interaction comprises one or more request parameters associated with the request, memory access patterns during the processing of the data interaction, delays incurred during the processing of the data interaction, network activity during the processing of the data interaction, or a combination thereof.

4. The system of claim 1, wherein the processor is further configured to detect that an anomalous activity has occurred relating to processing of the data interaction in response to detecting one or more of:
one or more unusual request parameters received as part of the request;
the processing of the data interaction takes longer than expected;
unusual memory access patterns during the processing of the data interaction; or
multiple requests for the data interaction are received within a pre-configured time period.

5. The system of claim 1, wherein the processor is further configured to obfuscate the software code comprised in the response using one or more code obfuscation methods comprising name obfuscation, control flow obfuscation, string obfuscation, code splitting, code merging, dead code insertion, control flow flattening, code substitution, function inlining, context-aware string obfuscation, polymorphic code generation, or a combination thereof.

6. The system of claim 1, wherein the processor is further configured to:
in response to determining that an anomalous activity has occurred relating to processing of the data interaction:
generate a first hash key value based on a first set of data values received as part of the request, wherein the first set of data values are associated with a plurality of parameters configured to define a digital identity of the first user;
compare the first hash key value to a verified second hash key value associated with the first user, wherein the verified second hash key value is generated based on a verified second set of data values associated with the plurality of parameters;
in response to detecting, based on the comparing, that the first hash key value does not match with the second hash key value:
determine that the digital identity of the first user is not authenticated;
stop processing of the requested data interaction; and
generate an alert indicating that the digital identity of the first user is not authenticated.

7. The system of claim 6, wherein the verified second hash key value is associated with a Non-Fungible Token (NFT) that uniquely identifies the digital identity of the first user.

8. A method for securing a computing network, the method comprising:
detect a request from a first user to perform a data interaction;
detect that processing of the requested data interaction is initiated;
monitor a set of parameters associated with the processing of the requested data interaction;
determine, based on the monitoring, whether anomalous activity has occurred relating to processing of the data interaction, wherein the anomalous activity comprises at least one activity not known to normally occur when processing the data interaction;
in response to determining that no anomalous activity has occurred relating to processing the data interaction, obtain a response associated with the processing of the data interaction, wherein the response comprises software code to be executed by a user device to present at least a portion of the response on a display associated with the user device;
obfuscate at least a portion of the software code comprised in the response;
replace the portion of the software code with the obfuscated software code in the response; and
transmit to the user device, the response including the obfuscated software code.

9. The method of claim 8, wherein the obfuscated code is configured to be decoded and executed by the user device to present at least the portion of the response on the display associated with the user device.

10. The method of claim 8, wherein the set of parameters associated with the processing of the requested data interaction comprises one or more request parameters associated with the request, memory access patterns during the processing of the data interaction, delays incurred during the processing of the data interaction, network activity during the processing of the data interaction, or a combination thereof.

11. The method of claim 8, further comprising detecting that an anomalous activity has occurred relating to processing of the data interaction in response to detecting one or more of:
one or more unusual request parameters received as part of the request;
the processing of the data interaction takes longer than expected;
unusual memory access patterns during the processing of the data interaction; or
multiple requests for the data interaction are received within a pre-configured time period.

12. The method of claim 8, further comprising obfuscating the software code comprised in the response using one or more code obfuscation methods comprising name obfuscation, control flow obfuscation, string obfuscation, code splitting, code merging, dead code insertion, control flow flattening, code substitution, function inlining, context-aware string obfuscation, polymorphic code generation, or a combination thereof.

13. The method of claim 8, further comprising:
in response to determining that an anomalous activity has occurred relating to processing of the data interaction:
generating a first hash key value based on a first set of data values received as part of the request, wherein the first set of data values are associated with a plurality of parameters configured to define a digital identity of the first user;
comparing the first hash key value to a verified second hash key value associated with the first user, wherein the verified second hash key value is generated based on a verified second set of data values associated with the plurality of parameters;
in response to detecting, based on the comparing, that the first hash key value does not match with the second hash key value:
determining that the digital identity of the first user is not authenticated;
stopping processing of the requested data interaction; and
generating an alert indicating that the digital identity of the first user is not authenticated.

14. The method of claim 13, wherein the verified second hash key value is associated with a Non-Fungible Token (NFT) that uniquely identifies the digital identity of the first user.

15. A non-transitory computer-readable medium storing instructions that when executed by a processor causes the processor to:
detect a request from a first user to perform a data interaction;
detect that processing of the requested data interaction is initiated;
monitor a set of parameters associated with the processing of the requested data interaction;
determine, based on the monitoring, whether anomalous activity has occurred relating to processing of the data interaction, wherein the anomalous activity comprises at least one activity not known to normally occur when processing the data interaction;
in response to determining that no anomalous activity has occurred relating to processing the data interaction, obtain a response associated with the processing of the data interaction, wherein the response comprises software code to be executed by a user device to present at least a portion of the response on a display associated with the user device;
obfuscate at least a portion of the software code comprised in the response;
replace the portion of the software code with the obfuscated software code in the response; and
transmit to the user device, the response including the obfuscated software code.

16. The non-transitory computer-readable medium of claim 15, wherein the obfuscated code is configured to be decoded and executed by the user device to present at least the portion of the response on the display associated with the user device.

17. The non-transitory computer-readable medium of claim 15, wherein the set of parameters associated with the processing of the requested data interaction comprises one or more request parameters associated with the request, memory access patterns during the processing of the data interaction, delays incurred during the processing of the data interaction, network activity during the processing of the data interaction, or a combination thereof.

18. The non-transitory computer-readable medium of claim 15, wherein the instructions further cause the processor to detect that an anomalous activity has occurred relating to processing of the data interaction in response to detecting one or more of:
one or more unusual request parameters received as part of the request;
the processing of the data interaction takes longer than expected;
unusual memory access patterns during the processing of the data interaction; or
multiple requests for the data interaction are received within a pre-configured time period.

19. The non-transitory computer-readable medium of claim 15, wherein the instructions further cause the processor to obfuscate the software code comprised in the response using one or more code obfuscation methods comprising name obfuscation, control flow obfuscation, string obfuscation, code splitting, code merging, dead code insertion, control flow flattening, code substitution, function inlining, context-aware string obfuscation, polymorphic code generation, or a combination thereof.

20. The non-transitory computer-readable medium of claim 15, wherein the instructions further cause the processor to:
in response to determining that an anomalous activity has occurred relating to processing of the data interaction:
generate a first hash key value based on a first set of data values received as part of the request, wherein the first set of data values are associated with a plurality of parameters configured to define a digital identity of the first user;
compare the first hash key value to a verified second hash key value associated with the first user, wherein the verified second hash key value is generated based on a verified second set of data values associated with the plurality of parameters;
in response to detecting, based on the comparing, that the first hash key value does not match with the second hash key value:
determine that the digital identity of the first user is not authenticated;
stop processing of the requested data interaction; and
generate an alert indicating that the digital identity of the first user is not authenticated.
